(19) United States
(12) Patent Application Publication
(10) Pub. No.: US 2026/0168595 A1
(43) Pub. Date: Jun. 18, 2026

(54) UNIVERSAL FRAMING MEMBER SERVICE OPENING ADAPTERS AND ACCESSORIES

(71) Applicant: Ann Schuessler, Chicago, IL (US)

(72) Inventor: Ann Schuessler, Chicago, IL (US)

(21) Appl. No.: 19/417,919

(22) Filed: Dec. 12, 2025

Related U.S. Application Data
(60) Provisional application No. 63/735,691, filed on Dec. 18, 2024.

(51) Int. Cl. F16L 3/12; F16L 3/02; F16L 3/237; F16L 5/00

(52) U.S. Cl. CPC F16L 3/1222; F16L 3/02; F16L 3/237; F16L 5/00

(57) ABSTRACT

A universal framing member service opening adaptor system for organizing and protecting utilities routed through framing members is disclosed. The system includes an adaptor having an inner frame defining a service hole opening, a flange member extending from the inner frame, and coupling members configured to secure the adaptor within a framing member service openings without tools or fasteners. Modular securing members snap onto the adaptor for specialized utility management, including pipe holder securing members with flexible clamping mechanisms, cable holder modular securing members with relief features for flexing, and zip tie securing members with accessory attachment openings. In another aspect, a twistset service opening adapter is provided, configured to rotate and lock within internal channels of a C-shaped framing member, with engagement members featuring slots, openings, or threaded attachment mechanisms for routing or securing utilities.

### CROSS-REFERENCE TO RELATED APPLICATION

The present application claims priority to and the benefit of U.S. Provisional Application No. 63/735,691, filed Dec. 18, 2024, the contents of which are incorporated herein by reference and made a part hereof.

### BACKGROUND OF THE INVENTION

The present invention generally relates to adaptor components for service holes in construction framing. More particularly the invention relates to adaptor components configured to provide additional utility and functionality to pre-existing slotted or circular service holes.

Light gauge steel framing is commonly used in residential and commercial construction because of its strength, uniformity, and resistance to warping. These framing members typically include pre-punched service holes or framing member service openings intended to allow passage of electrical wiring, low-voltage cabling, and plastic piping. However, in practice, routing these utilities through the framing remains a significant challenge. Installers often struggle to manage multiple cables and plastic piping through the limited openings.

Accordingly, there is a need for a system that enables fast, accurate, and secure placement of mechanical, electrical, and plumbing components within light gauge steel framing, without requiring tools or fastener, while improving organization, protection, and overall installation quality.

### SUMMARY OF THE INVENTION

In light of the above, the present invention provides adaptor components configured to provide additional utility and functionality to framing member service openings. One of skill in the art would recognize that framing member service openings may come in a plurality of shapes, including but not limited to slotted, square, rectangular, circular or elliptical, as such the adaptor components as described may have varying perimeter shapes to accommodate the particular framing member service opening.

In one aspect, the invention provides a universal framing member service opening adaptor system designed to provide abrasion protection and the ability to secure pipes or cables to framing members without the use of screws and to improve the routing and organization of pipes, cables, and wires through framing members, particularly light gauge steel framing. The system includes an adaptor configured to couple to the boundary of a framing member service openings and provide a smooth, protective interface for utilities passing through. The adaptor comprises an inner frame defining a service hole opening, a flange member extending from the frame, and coupling members such as compressible tabs that allow the adaptor to snap-fit into the framing member service openings without tools or fasteners. In some embodiments, the adaptor may be secured by compression fit, magnetic engagement, or removable fasteners.

The universal adaptor is further configured to receive and retain modular securing members for specialized utility management. Examples of modular securing members include a pipe holder securing member with flexible clamping mechanisms for securing pipes, a cable holder securing member with relief features for compression and flexing, and a zip tie securing member with openings to secure zip ties and for accessory attachments. Each modular securing member is designed to snap onto the universal adaptor's inner frame and flange for quick installation. Optional accessories, such as T-bar attachments, enable parallel routing of pipes or cables. Alternate embodiments include circular versions of the adaptor and modular securing members for round service holes, modular securing members with deformable fins for gripping pipes or cables, and integrated configurations combining the adaptor and modular securing members into a single component.

In another aspect, the invention provides a twistset service opening adapter configured to engage and couple into a C-shaped framing member. The twistset adapter includes a body with front and rear sides and in some embodiments an engagement member configured to insert into a framing member service openings. The body is rotatable to fit between internal channels of the framing member and lock in place by rotation, securing the adapter without tools or fasteners. The engagement member may include slots or openings for routing cables or securing pipes, as well as threaded or industry-standard attachment mechanisms for fittings. Additional features may include chamfered or rounded edges to aid rotation and prevent binding, and optional openings in the body for internal organization within or through the framing member.

Together, these systems provide a modular, universal solution for organizing and securing utilities within framing structures, reducing installation time, improving safety, and maintaining neat, code-compliant routing.

### BRIEF DESCRIPTION OF THE DRAWINGS

In the accompanying figures, like elements are identified by like reference numerals among the several preferred embodiments of the present invention.

FIG. 1 illustrates a front perspective view of a universal framing member service opening adaptor.

FIG. 2 illustrates a rear perspective view of the universal framing member service opening adaptor.

FIG. 3 illustrates a circular embodiment of the universal framing member service opening adaptor.

FIG. 4. illustrates the universal framing member service opening adaptor with coupled modular securing members.

FIG. 5 illustrates a front perspective view of a pipe holder securing member.

FIG. 6 illustrates a front view of the pipe holder securing member.

FIG. 7 illustrates a front perspective view of a cable holder securing member.

FIG. 8 illustrates a front view of the cable holder securing member.

FIG. 9 illustrates the universal framing member service opening adaptor with coupled zip tie securing member.

FIG. 10 illustrates a front view of a T-bar securing member.

FIG. 11 illustrates a front perspective view of a T-bar securing member coupled to a zip tie securing member accessory opening.

FIG. 12 illustrates a circular embodiment of the pipe holder securing member.

FIG. 13 illustrates a bottom perspective view of the circular embodiment of the pipe holder securing member.

FIG. 14 illustrates a circular embodiment of the zip tie securing member.

FIG. 15 illustrates a bottom perspective view of the circular embodiment of the zip tie securing member.

FIG. 16 illustrates an alternate cable or pipe modular securing member with deformable fins.

FIG. 17 illustrates a bottom perspective view of the alternate cable or pipe modular securing member.

FIG. 18-20 illustrates a universal framing member service opening adaptor with integrated or formed securing member accessories or openings.

FIGS. 21-22 illustrate the universal framing member service opening adaptor coupled to a framing member.

FIG. 23 illustrates a front perspective view of a twistset service opening adapter.

FIG. 24 illustrates a rear perspective view of a twistset service opening adapter.

FIG. 25 illustrates a front perspective view of the twistset service opening adapter installed in a frame member.

FIG. 26 illustrates a rear perspective view of the twistset service opening adapter installed in a frame member.

FIGS. 27-32 illustrate variations of the twistset service opening adapter body including additional slots or openings for internal organization of cables or pipes within the framing member.

Other aspects and advantages of the present invention will become apparent upon consideration of the following detailed description, wherein similar structures have similar reference numerals.

### DETAILED DESCRIPTION OF THE PREFERRED EMBODIMENTS

The foregoing and other features and advantages of the invention will become more apparent from the following detailed description of an exemplary embodiment, read in conjunction with the accompanying drawings. The detailed description and drawings are merely illustrative of the invention rather than limiting, the scope of the invention being defined by the appended claims and equivalents thereof.

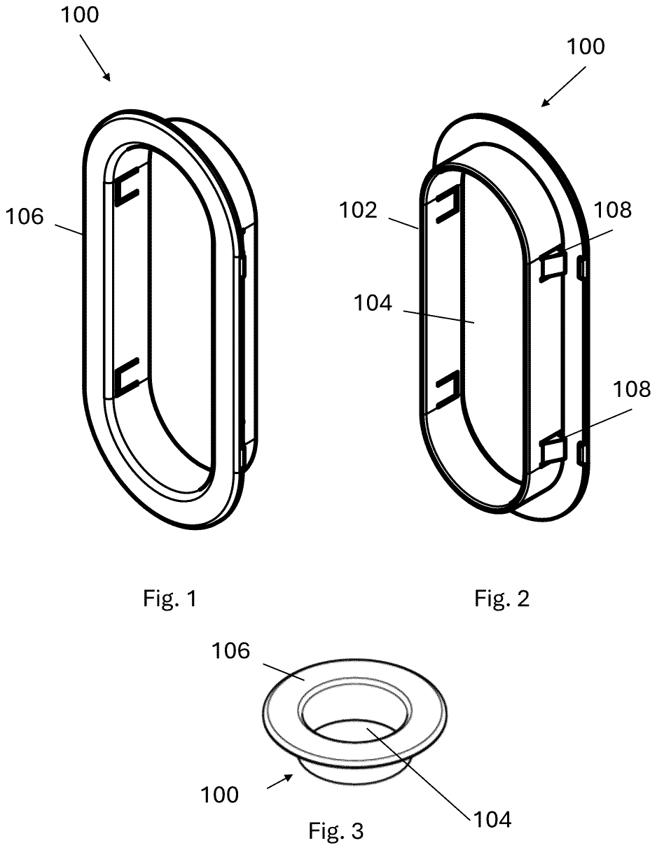

FIG. 1 and FIG. 2 show front and rear perspectives of a universal framing member service opening adaptor 100. The universal framing member service opening adaptor 100 comprises an inner frame 102, a service hole opening 104 defined by the inner frame 102, and a flange member 106 extending from the inner frame 102. The inner frame 102 may further comprise coupling members 108, including but not limited to compressible tabs configured to snap into a framing member service opening boundary, constraining the framing member service opening boundary between the coupling members 108 and the flange member 106. In some aspects the inner frame 102 may be coupled to the to the framing member service opening boundary through a compression fit. In operation, the universal framing member service opening adaptor 100 is pressed into and coupled to a framing member service opening leaving a an open service hole with safer inner frame 102 to interact with instead of the sharp boundary of the framing member service opening. The universal framing member service opening adaptor 100 acts to guide, protect, and facilitate wires, pipes, or other utilities through the framing member service opening and protect the wires and pipes from damage caused by the surface of the rough or sharp edges of the framing member service opening. As different frames have different shaped service openings, FIG. 3 shows a circular embodiment of the universal framing member service opening adaptor 100 configured for circular service openings.

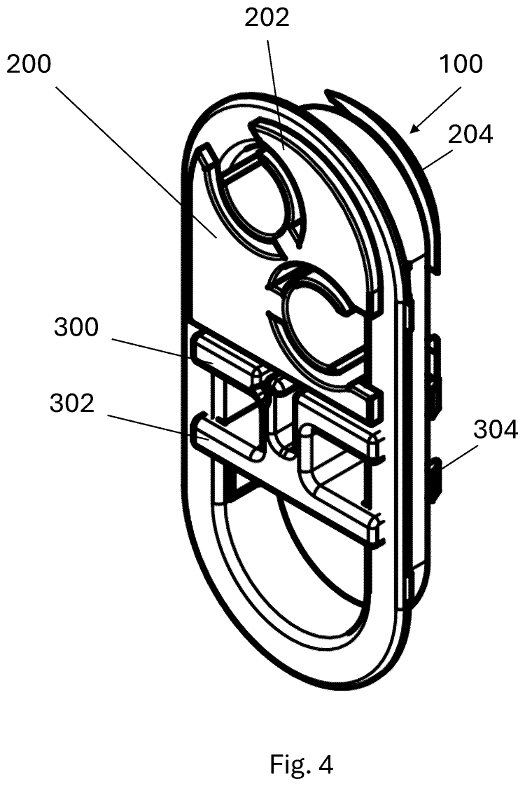

As shown in FIG. 4 and described further below, the universal framing member service opening adaptor 100 may be further configured to adapt and accommodate additional modular securing members 200, 300, 400 for a particular pipe, wire, cable or zip. In some aspects, modular securing members may comprise a front surface, a rear surface, and an inner frame guide and further wherein the front surface is configured to couple over the flange member 106 and the rear surface is configured to couple over a bottom portion of the inner frame 102 snapping the modular securing member into place.

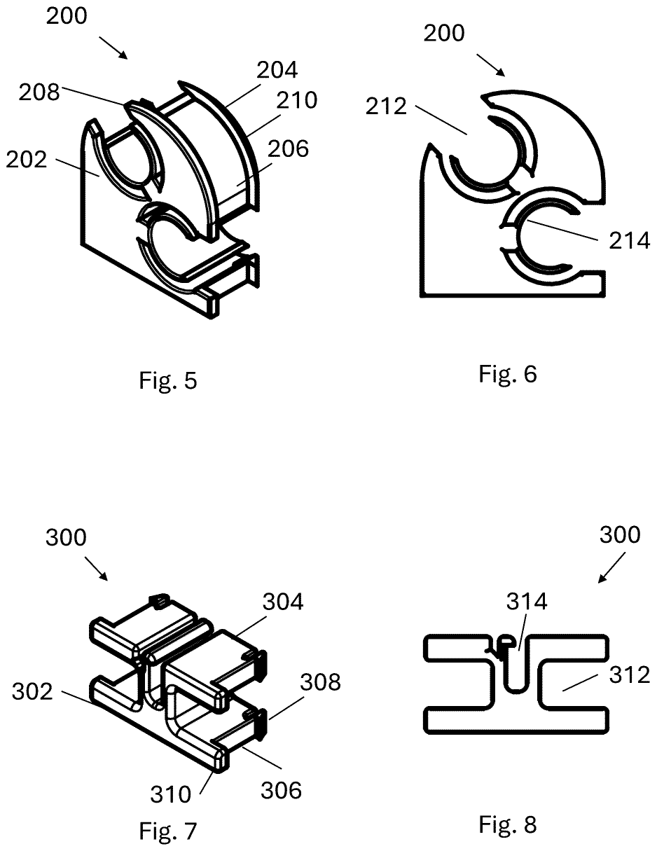

FIGS. 5 and 6 provide an example of a pipe holder securing member 200. The pipe holder securing member 200 comprises a pipe holder securing member front side 202, a pipe holder securing member rear side 204 an inner frame guide 206, and at least one pipe opening 208. In the configuration shown the pipe holder securing member front surface 208 and pipe holder securing member rear surface 210 extend beyond the inner frame guide 206. In this configuration, the pipe holder securing member front surface 202 and pipe holder securing member rear surface 210 are configured to couple to or snap onto the bottom edge of the inner frame 102 and the top surface of the flange member 106. In some aspects, the at least one pipe opening 212 is “C” shaped or semi-circular and further comprises a flexible clamping mechanism 214 allowing for a pipe to more easily be assembled an clamped into place. The pipe holder securing member 200 may be configured with at least a partial boundary shape conforming to the universal framing member service opening adaptor 100 boundary.

FIGS. 7 and 8 provide an example of a cable holder securing member 300. The cable holder securing member 300 comprises a cable holder securing member front side 302, a cable holder securing member rear side 304 an inner frame guide 306, and at least one cable opening 308. In the configuration shown the cable holder securing member front surface 310 and cable holder securing member rear surface 312 extend beyond the inner frame guide 306. In this configuration, the cable holder securing member front surface 302 and cable holder securing member rear surface 304 are configured to couple to or snap onto the bottom edge of the inner frame 102 and the top surface of the flange member 106. In some aspects, the cable holder securing member 300 comprises a cable holder securing member relief 314 configured to allow the cable holder securing member 300 to compress and flex for assembly and into and disassembly out of the universal framing member service opening adaptor 100. The cable holder securing member 300 may be configured with at least a partial boundary shape conforming to the universal framing member service opening adaptor 100 boundary.

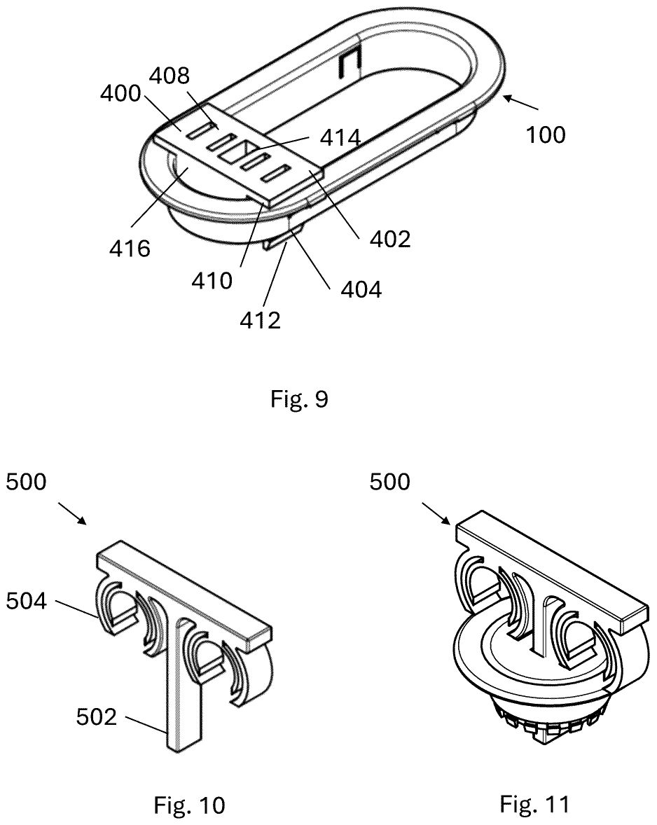

FIG. 9 provides an example of a zip tie securing member 400 coupled to an adapter member 100. The zip tie securing member 400 comprises a zip tie securing member front side 402, a zip tie securing member rear side 404 an inner frame guide 406, and at least one zip tie opening 408 configured to receive a zip tie. In the configuration shown the zip tie securing member front surface 410 and zip tie securing member rear surface 412 extend beyond the inner frame guide 406. In this configuration, the zip tie securing member front surface 402 and zip tie securing member rear surface 404 are configured to couple to or snap onto the bottom edge of the inner frame 102 and the top surface of the flange member 106. In some aspects, the zip tie securing member 400 comprises an accessory attachment opening 414. The zip tie securing member 400 may be configured with at least a partial boundary shape conforming to the universal framing member service opening adaptor 100 boundary.

FIGS. 10 and 11 display an example T-bar securing member 500 ant the T-bar securing member 500 coupled to an example circular zip tie securing member 400. The T-bar attachment 500 comprises an elongated stem portion 502 configured to be inserted and retained in the accessory attachment opening 410. In the configuration shown, the T-bar attachment 500 extends normal to the zip tie securing member 400 and further comprises additional pipe or cable clamps 504 extending from a second end of the stem portion 502 configured to run the pipe or cable parallel to the universal framing member service opening adaptor 100.

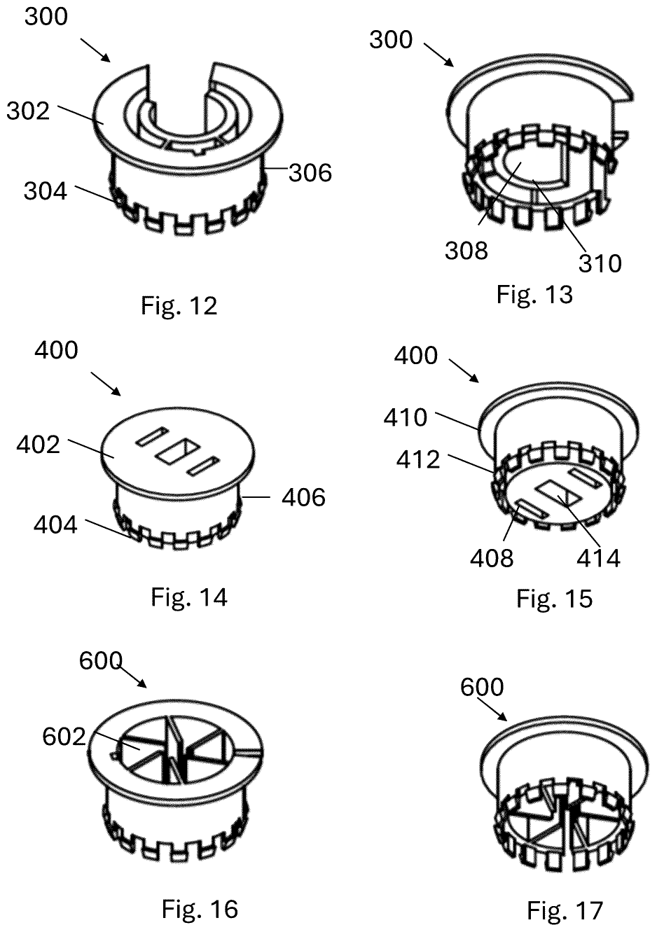

As different frames have different shaped service openings, FIGS. 12 and 13 show a circular embodiment of the pipe holder securing member, and FIGS. 14 and 15 show a circular embodiment of the zip tie securing member 400. FIGS. 16 and 17 show an alternate cable or pipe modular securing member 600 comprising fins 602 configured to deform and compress around an inserted pipe or cable and hold it in place.

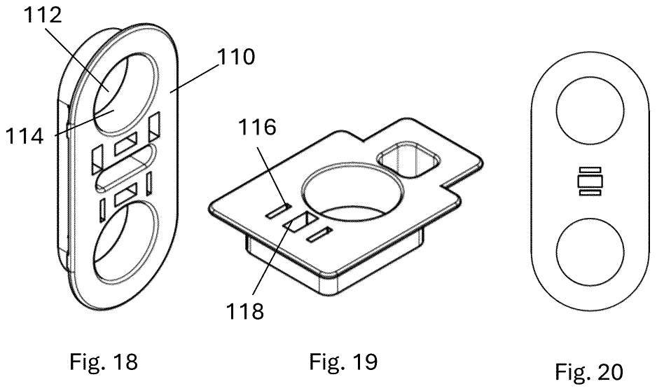

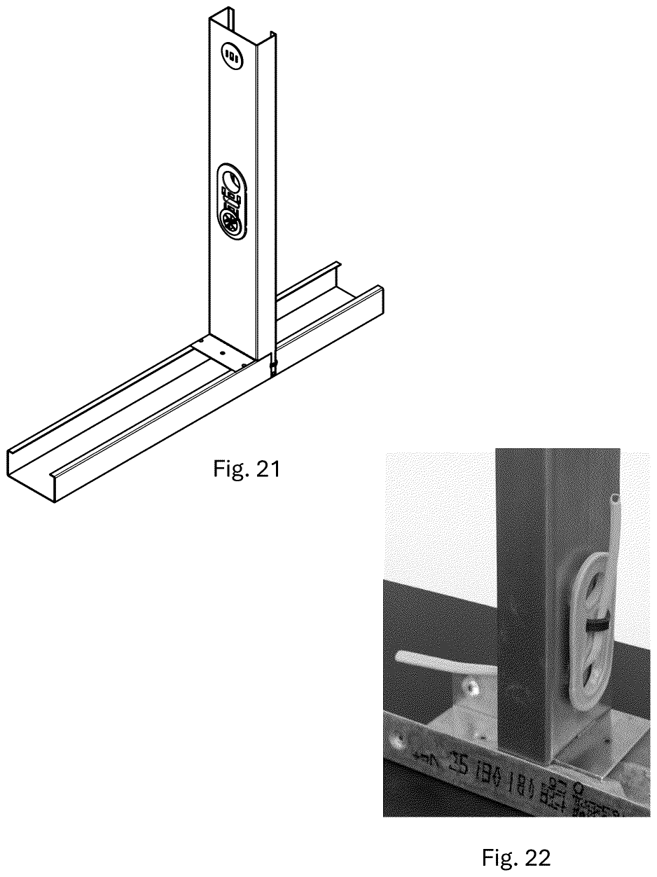

One of skill in the art would recognize that while each of these modular securing members may be configured as individual components configured to couple to the universal framing member service opening adaptor 100, or, as shown in FIGS. 18, 19, and 20 various universal framing member service opening adaptor 100 configurations comprise the modular securing member features or openings integrated therein. As shown in these configurations, the inner frame 102 and the flange member 106 extend from an adaptor front surface 110, at least a first modular securing member opening 112 is disposed in the adaptor front surface 110, and the modular securing member opening 112 comprises a modular securing member frame 114 extending from the adaptor front surface 110 bounding the modular securing member opening 112. In some configurations, as shown, at least one of a zip tie opening 116 configured to accommodate a zip tie fastener or an accessory attachment opening 118 configured to receive an accessory attachment is disposed in the adaptor front surface 110. FIGS. 21 and 22 shows these iterations coupled to a framing member. FIG. 22 shows a cable routed through a modular securing member opening 112 secured with a zip tie coupled to the zip tie opening 116.

To assemble the universal framing member service opening adaptor 100, the installer first identifies the framing member service hole where utilities will pass through. The universal framing member service opening adaptor 100 is aligned with the service hole and pressed into place so that the inner frame 102 seats within the hole and the flange member 106 rests against the outer surface of the framing. Coupling members 108, such as compressible tabs, engage the hole boundary to secure the adaptor without tools or fasteners. In some embodiments, the adaptor may be secured by compression fit.

Once the adaptor 100 is installed, the desired modular securing member, such as the pipe holder securing member 200, cable holder securing member 300, or zip tie securing member 400, is selected based on the utility to be routed. Each modular securing member includes an inner frame guide 206, 306, or 406 and is positioned against the inner frame 102 and flange member 106, then snapped into place using its integrated coupling features. For example, the pipe holder securing member 200 includes at least one pipe opening 208 with a flexible clamping mechanism 210 for securing pipes, while the cable holder securing member 300 includes cable openings 308 and a relief feature 310 for flexing during installation. The zip tie securing member 400 includes zip tie openings 408 and may incorporate an accessory attachment opening 410 for additional components such as the T-bar attachment 500.

After assembly, utilities such as pipes, cables, or wires are routed through the service hole opening 104 of the universal framing member service opening adaptor 100 and secured within the corresponding modular securing member. For pipe installations, the pipe holder securing member 200 clamps the pipe within the pipe opening 208. For cable installations, the cable holder securing member 300 guides and retains cables within the cable opening 308, while the relief feature 310 ensures a secure fit. For zip tie organization, the zip tie securing member 400 allows zip ties to pass through openings 408 to bundle and secure cables or pipes. Optional accessories, such as the T-bar attachment 500, may be inserted into the accessory attachment opening 410 to provide additional clamps 504 for parallel routing.

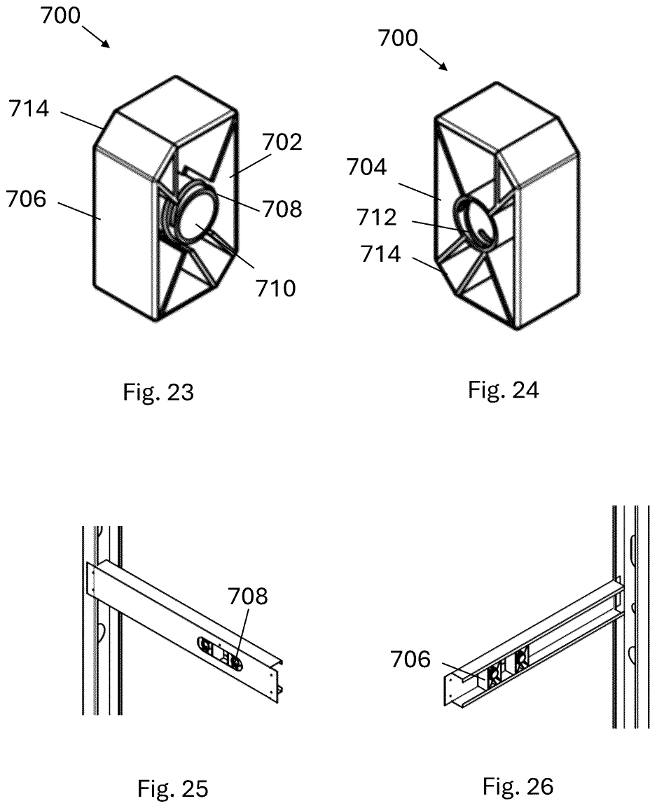

In another aspect, as shown in FIG. 23 and FIG. 24 the invention comprises a twistset service opening adapter 700 having various configurations intended to hold pipes, cables, wires, fittings, etc. The twistset service opening adapter 700 is configured to engage and couple into a “C” shaped framing member. The twistset service opening adapter 700 comprises a twistset service opening adapter front side 702, a twistset service opening adapter rear side 704, a twistset service opening adapter body 706 bound between the twistset service opening adapter front side 702 and twistset service opening adapter rear side 704, and twistset service hole engagement member 708 configured to engage a framing member service hole. The twistset service hole engagement member 708 may comprise a slot or openings 710 to route cables or secure pipes through the framing member. As further shown in FIG. 23 and FIG. 24 the twistset service hole engagement member 708 may comprise male or female threading or similar industry attachment mechanisms 712.

In some aspects the twistset service opening adapter body 706 may further comprise at least one chamfered or rounded edge 714 configured to aid in of the rotation service hole adapter body 706 such that the service hole adapter body 706 does not get stuck in rotation when its leading edge interfaces with the framing member internal “C” channels. In operation and as shown in FIG. 25 and FIG. 26, the service hole adapter body 706 is rotated to fit between the framing member internal “C” channels, the twistset service hole engagement member 708 is inserted into the framing member service hole, the service hole adapter body 706 is then rotated such the service hole adapter body 706 is bound by or constrained by the framing member internal “C” channels in one plane, while secured by the service hole boundary walls in the other planes.

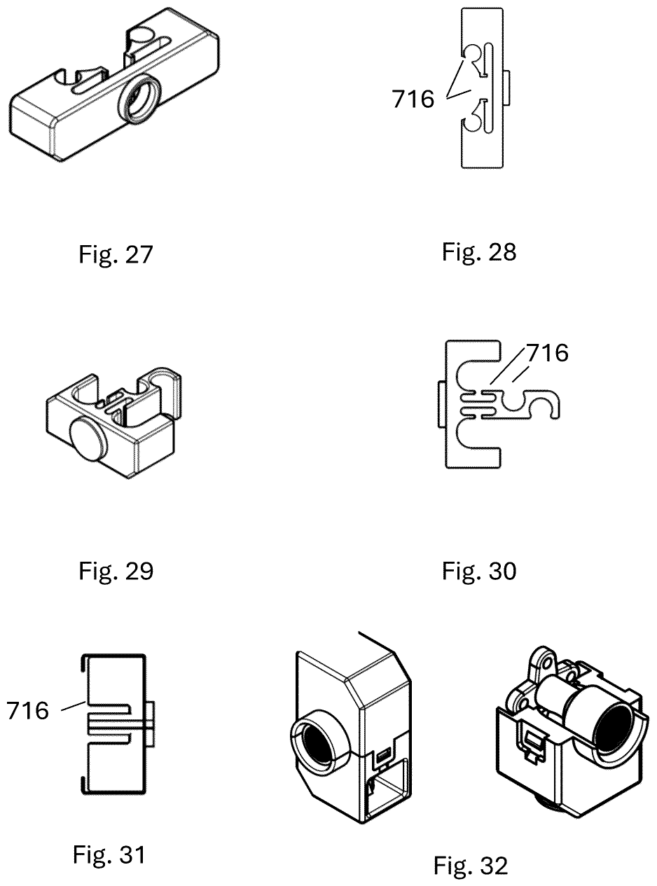

In additional aspects, as shown in FIGS. 27-32 twistset service opening adapter body 706 may comprise additional slots or openings 716 to provide internal organization within or through the framing member. FIG. 32 shows a twistset service opening adapter configured as two separate piece coupled together to enable the inclusion of specific components such as plumbing fittings.

Those of ordinary skill in the art will understand and appreciate the aforementioned description of the invention has been made with reference to a certain exemplary embodiment of the invention, which describe universal framing member service opening adapters and accessories and a method of use. Those of skill in the art will understand that obvious variations in construction, material, dimensions or properties may be made without departing from the scope of the invention which is intended to be limited only by the claims appended hereto.

1. A universal framing member service opening adaptor comprising:
an inner frame configured to engage and couple to a boundary of a framing member service opening;
a service hole opening defined by the inner frame;
a flange member extending from the inner frame;
wherein the adaptor is configured to receive and retain a modular securing member secured to the inner frame.

2. The universal framing member service opening adaptor of claim 1, wherein the inner frame comprises at least one coupling member, the coupling member having compressible tabs configured to snap-fit into the framing member service opening boundary, securing the framing member service opening boundary between the coupling member and the flange member.

3. The universal framing member service opening adaptor of claim 1, wherein the adaptor is coupled to the framing member service opening through a compression fit.

4. The universal framing member service opening adaptor of claim 1, wherein the modular securing member comprises a front side, a rear side, and an inner frame guide extending between the front side and the rear side, further wherein a front side surface extends beyond the inner frame guide and is configured to couple over the flange member, and the rear surface extends beyond the inner frame guide and is configured to couple over a bottom portion of the inner frame snapping the modular securing member into place.

5. The universal framing member service opening adaptor of claim 4, wherein the modular securing member comprises a pipe holder securing member having at least one pipe opening and a flexible clamping mechanism for securing a pipe.

6. The universal framing member service opening adaptor of claim 4, wherein the modular securing member comprises a cable holder securing member having at least one cable opening and a relief feature configured to allow compression and flexing during installation.

7. The universal framing member service opening adaptor of claim 4, wherein the modular securing member comprises a zip tie securing member having at least one zip tie opening configured to accommodate a zip tie fastener and an accessory attachment opening configured to receive an accessory attachment.

8. The universal framing member service opening adaptor of claim 7, wherein the accessory attachment comprises a T-bar attachment having an elongated stem portion configured to couple to the accessory attachment opening at a first end and at least one clamp for routing pipes or cables parallel to the adaptor extending from a second end.

9. The universal framing member service opening adaptor of claim 4, further comprising a pipe holder securing member having deformable fins configured to compress around an inserted pipe or cable.

10. The universal framing member service opening adaptor of claim 1, wherein the adaptor and modular securing members are configured with at least a partial perimeter shape conforming to the framing member service opening.

11. The universal framing member service opening adaptor of claim 1, wherein:
the inner frame extends from an adaptor front surface;
the flange member extends from the front surface;
at least a first modular securing member opening disposed in the front surface, the modular securing member opening having a modular securing member frame extending from the front surface bounding the modular securing member opening; and
wherein a modular securing member frame is configured to receive and retain a modular securing member.

12. The universal framing member service opening adaptor of claim 11 further comprising at least one of a zip tie opening configured to accommodate a zip tie fastener or an accessory attachment opening configured to receive an accessory attachment.

13. A method of assembling a universal framing member service opening adaptor system, comprising:
identifying a framing member service hole;
inserting an adaptor into the service hole such that an inner frame seats within the hole and a flange member rests against an outer surface of the framing member;
engaging at least one coupling member to secure the adaptor within the service hole;
selecting a modular securing member based on a utility to be routed;
coupling the modular securing member to the adaptor by snap-fitting the modular securing member onto the inner frame and flange member;
routing at least one utility through the service hole opening and securing the utility within the modular securing member.

14. The method of claim 13, wherein the modular securing member comprises a front side, a rear side, and an inner frame guide extending between the front side and the rear side, further wherein a front side surface extends beyond the inner frame guide and is configured to couple over the flange member, and the rear surface extends beyond the inner frame guide and is configured to couple over a bottom portion of the inner frame snapping the modular securing member into place.

15. The method of claim 13, wherein the modular securing member comprises a pipe holder securing member having a flexible clamping mechanism for securing a pipe.

16. The method of claim 13, wherein the modular securing member comprises a cable holder securing member having a relief feature configured to allow compression and flexing during installation.

17. The method of claim 13, wherein the modular securing member comprises a zip tie securing member having a zip tie opening to receive a zip tie.

18. The method of claim 13, wherein the modular securing member comprises an accessory attachment opening configured to receive a T-bar attachment having an elongated stem portion configured to couple to the accessory attachment opening at a first end and at least one clamp for routing pipes or cables parallel to the adaptor extending from a second end.

19. The method of claim 13, further comprising selecting a circular adaptor and modular securing member for a round service hole.

20. The method of claim 13, further comprising using a pipe holder securing member having deformable fins to grip a pipe or cable.
